(19) United States
(12) Patent Application Publication
(10) Pub. No.: US 2008/0073090 A1
(43) Pub. Date: Mar. 27, 2008

(54) Automated snow plow

(76) Inventor: Gary Harris, Hubbardston, MA (US)

Correspondence Address: Nields & Lemack, 176 E. Main Street, Suite #5, Westboro, MA, 01581, US

(21) Appl. No.: 11/888,710

(22) Filed: Aug. 2, 2007

Related U.S. Application Data
(60) Provisional application No. 60/847,275, filed on Sep. 26, 2006.

(51) Int. Cl. A01B 76/00; E01H 5/04; H01R 13/02

(52) U.S. Cl. 172/275; 37/231; 439/225

(57) ABSTRACT

The present invention comprises a working implement, such as a snowplow, that can be attached to a vehicle. The assembly contains its own power source, and is controlled remotely, such as wirelessly. This combination allows the operator of the vehicle to lift and lower the jack on the unattached working implement as required without exiting the vehicle. In one embodiment, the system further includes wireless remote control operation of the headlights and blinkers, thereby eliminating another physical connection that typically exists between the vehicle and the working implement. The wireless remote control operation of the jack enables proper positioning of the lift frame relative to the vehicle chassis for easy mounting and dismounting thereto. In certain embodiments, the engagement of the assembly's connection mechanism with the vehicle, such as with a receiver on the vehicle, creates an electrical connection that enables communication between the assembly and controls for the assembly.

This application claims priority of U.S. Provisional Application Ser. No. 60/847,275 filed Sep. 26, 2006, the disclosure of which is incorporated herein by reference.

### BACKGROUND OF THE INVENTION

Conventional snow blade mounts for four wheel drive vehicles such as pick-up trucks can weigh several hundred pounds, and generally include a chassis frame that can be permanently fixed to the vehicle chassis, usually behind the vehicle front bumper. A lift frame is then removably coupled to the chassis frame, and the snow blade is then coupled to the front end of the assembly via an A-frame and trip frame assembly. The A-frame with the snow blade attached is typically removable from the vehicle, and the lift frame can be permanently mounted to the chassis frame (and therefore not readily removable from the vehicle), or can be removed along with the A-frame and snow plow blade.

One drawback of conventional snow blade mounts is the difficulty in readily attaching and removing the assemblies from the vehicle chassis, especially in view of their weight. To that end, U.S. Pat. No. 5,125,174 discloses a removable snowplow including a removable lift frame and A-frame combination. However, the lift frame assembly is permanently mounted to the A-frame, thus requiring removal of both simultaneously, as a unit. U.S. Pat. No. 5,353,530 is of a similar vein.

Conventional mounting systems utilize a pin arrangement, whereby the vehicle and mount assembly must be properly aligned manually prior to coupling the mount to the chassis with a pair of pins. This mounting and dismounting is difficult and tedious.

U.S. Pat. No. 6,594,924, assigned to the instant assignee and the disclosure of which is incorporated herein by reference, discloses a snowplow having a jack. The unattached snowplow can be positioned, using the jack, at the correct height to allow easy engagement with the vehicle. The jack controls are positioned in an accessible location where the operator can visually inspect the height of the assembly, such as on the vehicle grill. Attached to the vehicle is a receiver plate, which accepts the lift frame of the snow plow. The receiver plate also includes an elongated rod or bar. The lift frame also comprises one or more latches, which attach to the rod to tightly couple the lift frame to the receiver plate. Thus, by extending the jack to the proper height, the vehicle's receiver plate is at the same height as the lift frame, enabling the operator of the vehicle to simply drive the vehicle onto the lift frame, thereby engaging the two when the latches reach their operative position. In operation, the operator is required to exit the vehicle to manually couple the electrical system of the vehicle to the snowplow. In most cases, a connector that allows rapid engagement is used. For example, the connector has at least two leads, corresponding to the leads of the vehicle battery. These leads are attached to a cable, which attached on its proximal end to the leads of the battery. Thus, the connections to the battery are made once. The connector is at the distal end of the cable and the cable is of sufficient length so that the connector is conveniently located so as to be accessible through the front of the vehicle, such as through or under the vehicle's grille. This connector then plus into a suitable mated connected that is located on the snowplow.

However, the position of the jack of the unused snowplow may change over time. This can be the result of the need to move the snowplow, accumulated snow on the ground, or a decrease in the resistance force holding the jack at this intended position. This requires the operator to manually adjust the height of the jack before the snowplow can be attached to the vehicle. Furthermore, after the attachment has been made, the operator must exit the vehicle to establish the electrical connections between the vehicle and the snowplow assembly.

It is an object of the present invention to provide a working implement mounting system that allows the operator to both attach and manipulate the working implement remotely, such as from the vehicle cab or outside the vehicle but remote from the location of the implement blade.

### SUMMARY OF THE INVENTION

The problems of the prior art have been overcome by the present invention, which comprises a working implement that can be attached to a vehicle, such as a snowplow assembly. The assembly contains its own power source, and is controlled remotely, such as wirelessly. This combination allows the operator of the vehicle to lift and lower the jack on the unattached working implement as required without exiting the vehicle. In one embodiment, the system further includes wireless remote control operation of the headlights and blinkers, thereby eliminating another physical connection that typically exists between the vehicle and the working implement. The wireless remote control operation of the jack enables proper positioning of the lift frame relative to the vehicle chassis for easy mounting and dismounting thereto. Furthermore, after the assembly has been properly positioned, the operator can wirelessly control the connection mechanism, such as one or more latches, to mount the assembly onto the vehicle. Thus, the operator can mount and dismount the implement assembly from within the truck without having to exit the vehicle. In certain embodiments, the engagement of the connection mechanism of the assembly with the vehicle, such as with a receiver on the vehicle, creates an electrical connection that enables communication between the assembly and controls for the assembly that are preferably located in the vehicle cab or passenger compartment. The lighting system can similarly be connected and disconnected without exiting the vehicle.

### BRIEF DESCRIPTION OF THE DRAWINGS

FIG. 1 is an exploded view of the mounting system of the present invention;

FIG. 2 illustrates the first step in the engagement process between the vehicle and the mounting system;

FIG. 3 illustrates the second step in the engagement process between the vehicle and the mounting system;

FIG. 4 illustrates the third step in the engagement process between the vehicle and the mounting system;

FIG. 5 illustrates the fourth step in the engagement process between the vehicle and the mounting system;

FIG. 6 illustrates the fifth and final step in the engagement process between the vehicle and the mounting system;

FIG. 7 illustrates one embodiment of the wireless transmitter used in accordance with the present invention;

FIG. 8 illustrates one embodiment of the implement hydraulic system used with the transmitter of FIG. 7;

FIG. 9 illustrates a more detailed embodiment of the implement hydraulic system used with the transmitter of FIG. 7;

FIG. 10 illustrates a second embodiment of the wireless transmitter used in accordance with the present invention;

FIG. 11 illustrates one embodiment of the implement hydraulic system used with the transmitter of FIG. 10;

FIG. 12 illustrates one embodiment of the vehicle's lighting system as configured in the present invention;

FIG. 13 illustrates one embodiment of the implement's lighting system used in conjunction with the vehicle lighting system of FIG. 12;

FIG. 14 illustrates one embodiment of a wiring scheme between the implement assembly and the vehicle;

FIG. 15 illustrates a second embodiment of a wiring scheme between the implement assembly and the vehicle;

FIG. 16 illustrates one embodiment of a wiring scheme for the implement assembly lighting system and movement of the implement; and

FIG. 17 illustrates one embodiment of the implement's lighting system used in conjunction with the vehicle lighting system of FIG. 16.

### DETAILED DESCRIPTION OF THE INVENTION

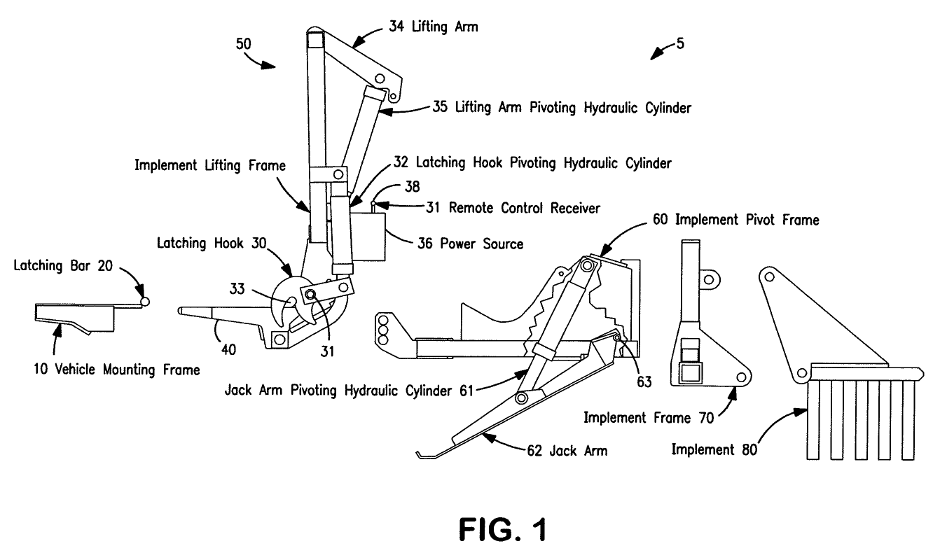

FIG. 1 shows an exploded view of a mounting system of the present invention. A vehicle mounted receiver member 10 is attached to the vehicle, preferably to the chassis frame by means of pins or bolts, although other methods of attachment such as welding are also possible. The actual design of the receiver member 10 interface for attachment to the chassis will depend upon the identity and design of the particular chassis and is well within the skill in the art.

The receiver member 10 preferably remains permanently mounted to the vehicle chassis, regardless of whether the snow blade or other accessories are in use. It is fixed and has no moving parts; its main function being to provide an attachment point for the working implement assembly. The receiver member 10 is preferably made of ⅜″ mild steel and includes a round elongated bar or rod 20 at the end which first engages the working implement assembly. The rod is preferably solid, 1″ in diameter and affixed to the receiver member 10 by suitable means, such as by welding. The rod 20 can extend horizontally a distance sufficient to be engaged at or near its opposite ends by one or more latch hooks discussed in detail below. However, those skilled in the art will appreciate that the bar 20 need not be horizontal and need not be continuous; two bars could also be used at each end of the receiver member 10 as long as they are appropriately positioned for engagement with the latching hook(s) 30. The receiver member can include guide members to help ensure proper alignment of the working implement assembly. The spacing or volume between these guide members and the top of receiver member 10 is configured to accommodate the male end or ends 40 of the hitch assembly, and thus preferably define a trapezoidal wedge. The male end or ends 40 of the hitch assembly is thus also preferably trapezoidal in shape, with rounded corners to facilitate hitch engagement with the receiver. Stated differently, the male end or ends 40 is tapered such that the length of its free engaging end is shorter than the length of its opposite end coupled to the lift assembly. Similarly, the guide members of the receiver member 10 are configured and placed such that the receiver volume is tapered, with its end farthest from the vehicle front being shorter than the end at the bar 20. The guide members thus act as a track for receiving and aligning male end or ends. The male end need not be a single piece; the weight of the assembly can be reduced by employing two spaced discontinuous male portions tapering towards each other. Each male portion is configured to be received by corresponding spaced female guide members of the receiver member 10. The receiver member is similarly shaped, so as to properly engage with the tapered male end of the hitch assembly.

In certain embodiments, particularly where the working implement is a snow plow blade, the implement assembly 5 comprises the implement lift frame 50, the implement pivot frame 60, the implement frame 70 and the implement 80.

The implement lift frame assembly 50 includes one or more latching hooks 30, preferably a pair of spaced latching hooks for engagement to the receiver member 10. Preferably the latches 30 share a common pivot shaft 31, the pivot shaft 31 extending from one latch to the other so that movement of the two latches is coordinated; actuation of one latch results in a corresponding movement of the other latch. In this way, the movement of the latches 30 can be controlled by a single actuator 32 coupled to one of the latches. Alternatively, separate pivot pins could be used for each latch, with each latch having separate means for actuation. In one embodiment, two actuators are employed, such that the actuation of the second occurs after the first has substantially completed its movement. Those skilled in the art will appreciate that although it is preferred that the latch or latches be pivotable for engagement and disengagement with the receiver member, other forms of movement can be used, such as horizontal movement along a track.

Each latch has a hook shape preferably including an arcuate recess 33 corresponding in angle to the circumference of the bar 20, configured as a compound concentric cam. The latch is thereby adapted to receive the bar. Preferably the tip of the hook extends beyond the body of the latch. This design facilitates the grasping and interlocking of bar 20 of receiver member 10. When each latch is in the engaged, locked position about the rod 20, preferably the recess 33 faces away from the vehicle chassis.

Preferably the latching hooks 30 are controlled by one or more hydraulic cylinders 32. The downward movement of the cylinder 32 causes a rotation of the hook 30, thereby exposing the actuate recess 33 to the rod 20. Conversely, the upward compression of the cylinder 32 causes an opposite rotation of the latching hooks 30, thereby locking the lift assembly 50 to the receiver member 10, and specifically the rod 20. The lift assembly 50 also includes a lifting arm 34, also controlled by an actuator, preferably a hydraulic cylinder 35. Expansion of this cylinder 35 causes the lifting arm 34 to rise relative to the ground, while compression of the cylinder 35 causes the lifting arm 34 to lower. Typically, one end of a chain or the like (not shown) is attached to the distal end of the lifting arm 34. The opposite end of the chain is attached to the implement pivot frame 60. Thus, expansion of the lifting arm hydraulic cylinder 35 causes the raising of the lifting arm 34, which in turn causes the lifting of the implement pivot frame 60. This is the preferred mechanism used to raise and lower a snowplow blade or other working implement.

The implement assembly 5 also includes an independent power source 36, preferably a battery such as is used in an automobile or similar vehicle. Any device capable of storing energy can also be used, such as but not limited to gas power engines, hydraulic accumulators, or solar cells. This power source powers the actuator(s) that actuate the lift frame 50 and the implement pivot frame 60. For example, this power source 36 can power a pump that pumps hydraulic fluid communicating with various hydraulic cylinders associated with the lift frame 50 and the implement pivot frame 60. It is desirable that this power source 36 be dedicated to powering all of the actuators, although it is not required by the present invention. The power source 36 must power at least the latching hook(s) actuator(s) 32 and the jack arm actuator 61, in order to enable the remotely operated attachment of the assembly to the receiver and establish an electrical connection between the assembly and the implement controls without having to make a manual connection, as will be described in more detail below.

In another embodiment, a small amount of stored energy is available on the implement. The power source 36 is only required to actuate the latching hook(s) actuator(s) 32 and the jack arm actuator 61 when the implement is not attached to the vehicle. Thus, the power source 36 need only provide enough power to perform these tasks. Once the vehicle is attached, power from the vehicle can be used to power the implement, and optionally recharge the power source 36.

The implement lift assembly 50 includes a wireless receiver 37, adapted to receive wireless signals from a remote transmitter. The wireless receiver 37 comprises an antenna 38, necessary to receive the wireless signals. The particular wireless technology used is a design implementation decision, as technologies such as IR, Bluetooth®, R.F., microwave and others are all possible. Furthermore, the actual frequency used is an implementation decision; those parts of the electromagnetic spectrum commonly used include, but are not limited to infrared, radio frequency (R.F), and microwave. Although any part of the electromagnetic spectrum is useable, typically the frequency of the signals is less then 10 GHz. Since the lift assembly 50 is separate from the vehicle during the mounting process (as will be described below), the wireless receiver 37 must at least be capable of receiving a wireless signal to control the height of the jack 62 and control the movement of the latches 30. Optionally, all of the controls on the assembly, such as plow angle, lift, and headlights, can also be wirelessly controlled.

The implement lift assembly 50 is attached to the implement pivot frame 60 by suitable means, such as by bolts on either end of the implement pivot frame 60. A function of the implement pivot frame 60 is to hold the implement 80, such as a snowplow blade. Additionally, the implement pivot frame 60 allows angular movement of the implement 80, preferably through the use of actuators such as two hydraulic cylinders horizontally mounted on the implement pivot frame 60 (not shown). The position and operation of such cylinders is well known to one in the art. The pivot frame 60 pivots up and down with respect to the lift frame 50, in response to the movements of the lifting arm 34.

The implement pivot frame 60 also includes a jack 62. The jack 62 preferably includes a curved skid shoe portion and a relatively straight elongated portion. This assembly is pivotally coupled to the implement pivot frame 60 via a pin 63 through opposite side gussets (one shown). The jack 62 is lowered by an actuator 61, such as by actuation of a hydraulic cylinder attached to the jack 62, which causes rotational movement of the jack 62 about the axis of the pin 63. By lowering the jack 62 sufficiently to cause the jack to contact and bias against the ground or other substrate supporting the assembly, the entire assembly can be raised to the appropriate height for engagement of the assembly with the female receiving end of the receiver member 10 mounted on the vehicle. This design allows for raising or lowering of the jack 62 to virtually any extent within its range. The retraction or compression of this cylinder 61 causes the jack to be lifted to a stowed position. Alternatively, a spring return can be used to return the jack to its stowed position and compress the cylinder. As mentioned earlier, this jack actuator 61 is preferably controlled by the power source 36 located on the implement assembly.

The implement frame 70 is used to hold the working implement 80, such as but not limited to a snowplow blade, a brush, a broom, a rake, a shovel, etc. The implement frame 70 can be attached to the implement pivot frame 60 by suitable means, such as by bolts. Preferably, the implement frame 70 is mounted to the implement pivot frame 60 such that it can pivot about a vertical axis, thereby allowing the implement 80 to rotate to the left and to the right, as desired, using the actuators described earlier.

Having described the various components of the implement assembly and mounting system, the method of attaching the implement assembly to the vehicle will be discussed.

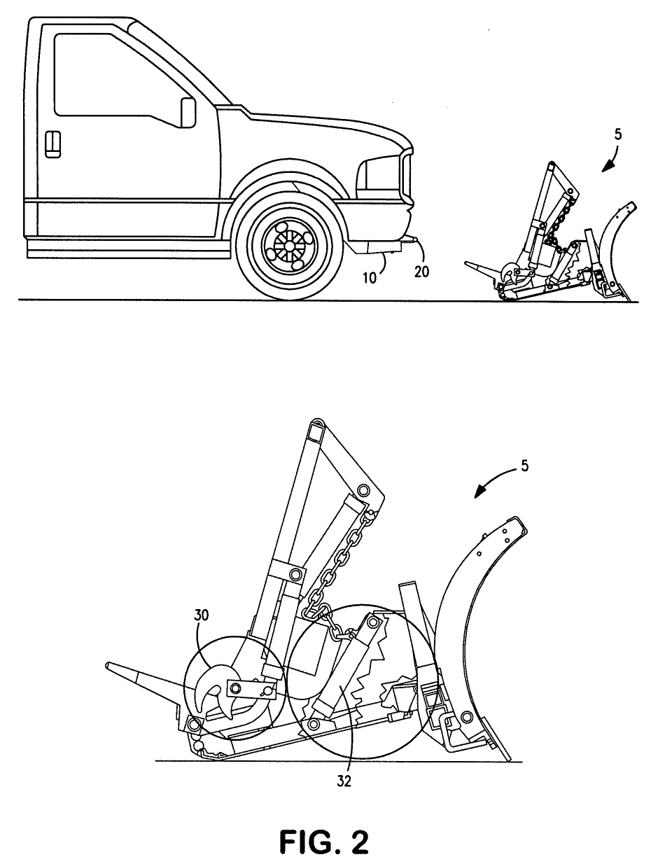

FIG. 2 shows the vehicle and the implement assembly to be attached. It illustrates the implement and associated mounting assembly in the disconnected, stored position, that is, the jack 62 has been retracted and the implement assembly 5 is resting on the ground or other surface. The latching hooks 30 are also in the closed position due to the position of the latching hook actuator 32 (e.g., a hydraulic cylinder in the retracted position). As the vehicle approaches the implement assembly 5, the operator horizontally aligns the vehicle with the assembly 5. This alignment can be aided by the use of line of sight markers located on the implement assembly 5. For example, a marker can be positioned on the implement lift frame in a location such that the operator can view the marker as the vehicle approaches, and align that marker with the center of the hood of the vehicle or some other fixed point. Alternatively, one or more position sensors located near the vehicle's receiving member 10 can be employed. The output from these sensors is linked to a visual display or other user interface near the operator, thereby enabling the operator to align the vehicle without leaving its interior. In this scenario, the operator is able to estimate the position of the implement assembly by studying the outputs of the various position sensors. In another embodiment, a small camera can be used to assist the operator in the alignment operation. Suitable cameras are currently used in newer automobiles to allow the operator to see behind the vehicle, as it is shown on a display typically near the dashboard. In another embodiment, a circuit is associated with each hook. When the rod of the vehicle contacts the latching hook, a visual indicator is activated. This can be done by taking advantage of the fact that the rod of the vehicle is grounded to complete the circuit. Regardless of the method used, the operator aligns the vehicle with the implement and associated mounted assembly. It is noted that precisely aligning the vehicle with the assembly is not required, as the configuration of the receiver member 10 and the implement assembly hitch member is such that they can accommodate errors in alignment without requiring the operator to back the vehicle up and begin the operation anew.

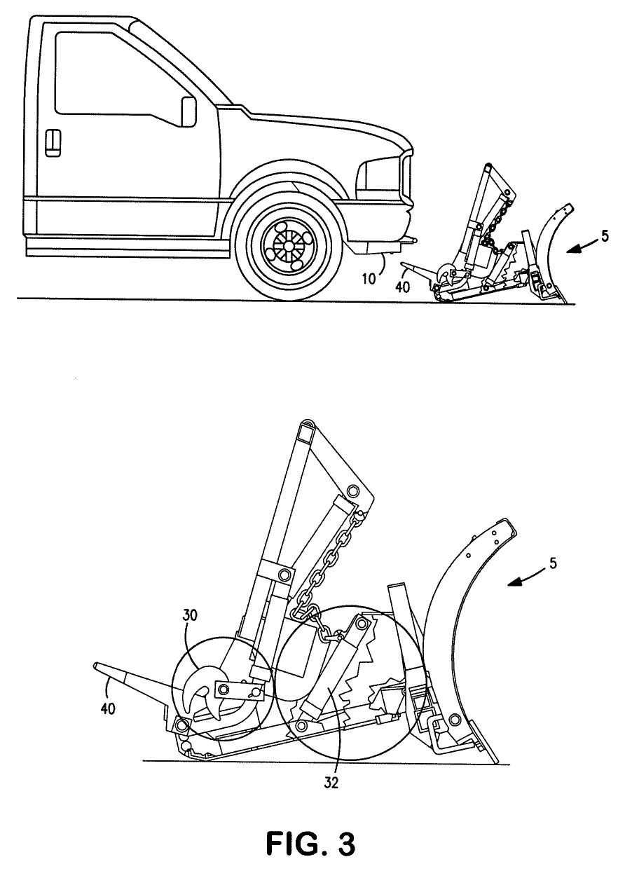

FIG. 3 shows a subsequent step in the engagement process. In this step, the vehicle has been brought forward so that the outermost portion of the male end or ends 40 of the implement lifting frame are positioned beneath the vehicle's receiver member 10. Again, visual aids, such as position sensors or line of sight markers can be used to enable the operator to properly position the vehicle with respect to the implement. The implement and associated mounting frame are still in the stored position.

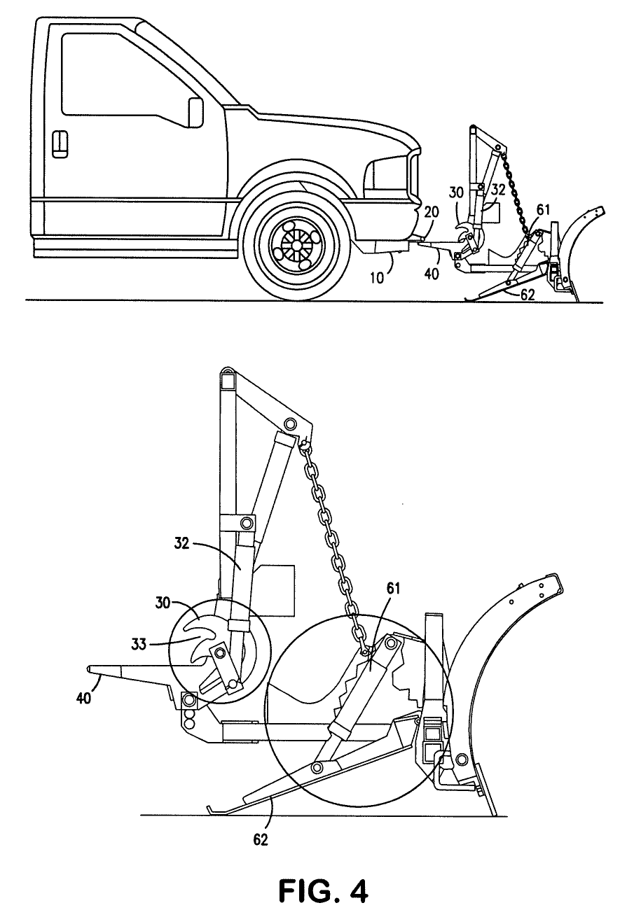

FIG. 4 shows the third step in the engagement process. Using the remote control, the operator actuates the jack 62, such as by causing the jack actuator 61 to be extended, thereby lowering the jack 62 and lifting the implement lift frame away from the ground to vertically align the assembly with the vehicle. In the preferred embodiment, the control of the jack actuator 61 is coupled to the control for the latching hook actuator 32. For example, extension of the jack cylinder 61 causes the extension of the latching hook cylinder 32, which in turn causes the latching hooks to rotate so as to expose the actuate openings 33 to the vehicle, and in particular, to the rod of the receiver member 10. Thus, when the jack 62 is extended, the latches 30 are positioned so as to accept the rod 20 from the vehicle. Conversely, the compression of the jack cylinder 61, which lifts the jack 62, also causes the latching hook cylinder 32 to rotate counterclockwise so as to grasp the rod 20. Alternatively, two separate controls can be employed; one for the jack actuator 61 and a second independent control for the latching hook actuator 32. Using the wireless transmitter, the jack 62 is lowered so as to cause the extending male end or ends 40 to lift and approach or contact the vehicle's receiver member 10. The latching hooks 30 are also rotated so as to be positioned to accept the rod 20.

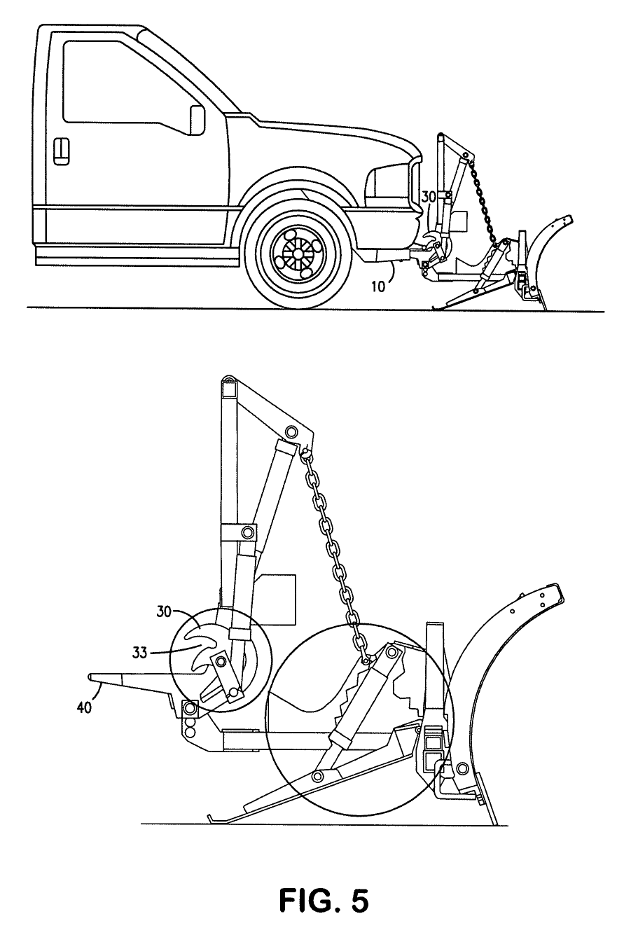

FIG. 5 illustrates a further subsequent step in the engagement process in which the vehicle operator moves the vehicle further towards the assembly. This action causes the extended male end or ends 40 to slide into the receiving member 10, aided by their trapezoidal wedge shape and the corresponding shape of the receiver. The vehicle continues forward until the rod 20 contacts the latch hooks 30 on the lift frame 50. The exact position of this contact may vary. FIG. 5 shows the rod 20 contacting the lower portion of the latching hook 30. Alternatively, the rod 20 may also enter the actuate opening 33 in the hook. Typically, the operator determines that contact between the rod 20 and the latches 30 has been achieved when he senses that the lift assembly is being pushed forward by the vehicle. At this point in time, the operator stops driving the vehicle forward.

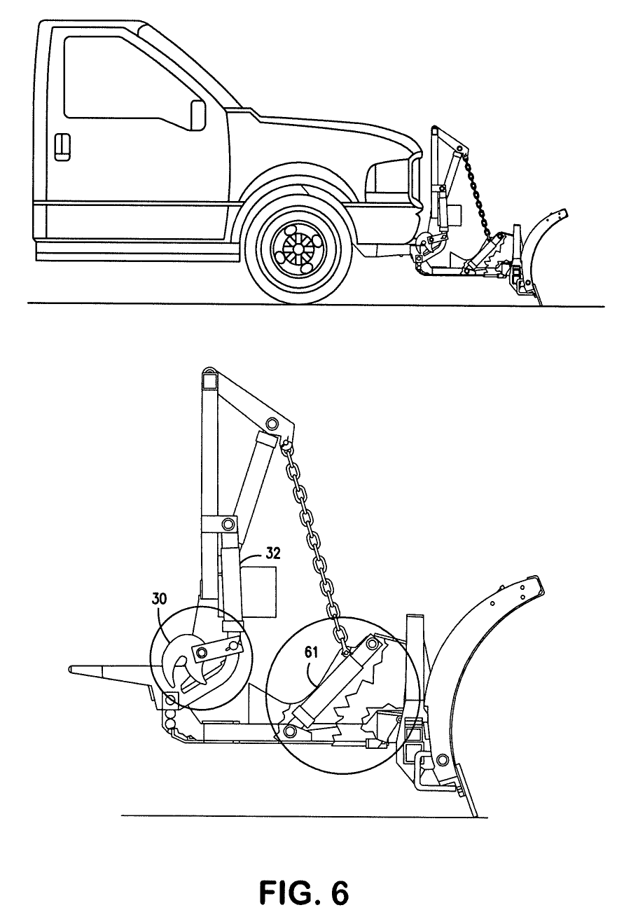

FIG. 6 shows the final step in the engagement process. The operator uses the wireless transmitter to actuate the actuators controlling the latch hooks 30 and the jack 62. For example, the transmitter can send one or more signals that cause the actuator 61 controlling the jack 62 and the actuator 32 controlling the latching hooks 30 to compress, thereby causing the latching hooks 30 to rotate around the rod 20 locking them in place, and causing the jack 62 to be retracted, thereby lifting it from the ground or other surface. The implement assembly is now mounted and ready for use.

Those skilled in the art will appreciate that some of the steps need not be carried out in the exact order set forth above. For example, the jack 62 could be actuated (and the assembly raised) during movement of the vehicle towards the assembly or after the vehicle has approached the assembly.

The implement assembly can be removed from the vehicle by performing these steps in reverse order. In this case, the operator uses the wireless transmitter to send a signal that causes the jack actuator 61 and latching hooks actuator(s) 32 to lower the jack 60 to the ground and rotate the latching hooks 30 so that the rod 20 is free to disengage therefrom. The implement assembly is then removed from the vehicle by moving the vehicle away from the assembly, typically by backing the vehicle away. The operator can then use the wireless transmitter to send a signal to lower the jack 62 to its retracted position. Alternatively, the implement lift frame 50 and implement 80 can be left in the position shown in FIG. 4 if so desired. In this case, only steps 3, 4 and 5 need to be performed to mount the implement on the vehicle at a later time.

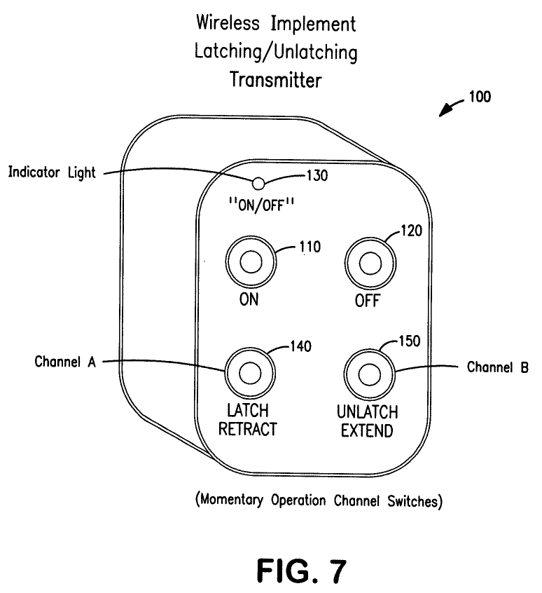

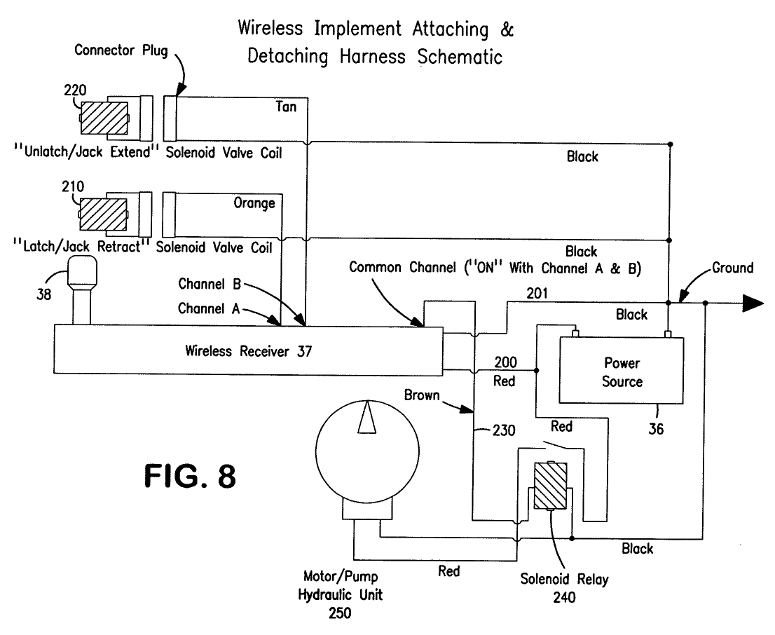

FIG. 7 shows a simple wireless transmitter 100 that can be utilized in the present invention. The wireless transmitter 100 can be located within the vehicle, on the vehicle, or worn by the operator. The location of the transmitter 100 is limited only by the operating range of the underlying wireless technology. For example, certain technologies require line of sight, while others have maximum operational distance specifications. In the preferred embodiment, the transmitter 100 employs a technology that does not rely on line of sight, such as radio frequency, and is located within the vehicle in the passenger compartment (although it need not be affixed within the compartment; it can be a stand-alone hand-held wireless remote control unit). As shown in FIG. 7, in one embodiment, the transmitter 100 includes an ON switch 110 and an OFF switch 120, as well as a power indicator 130. Thus, the user actuates the ON switch 110 to enable the wireless transmitter. This action also causes the power indicator 130 to light. By actuating the OFF switch 120, the operator disables the wireless transmitter 100. Alternatively, other configurations for the power function can be utilized. For example, a single switch can be used, wherein a single actuation of the switch enables the transmitter, and a second actuation disables it. Alternatively, a toggle switch can be used. Other embodiments of the power function are also well known in the art and are within the scope of the invention.

The transmitter also includes a LATCH/RETRACT switch 140 and an UNLATCH/EXTEND switch 150. These switches are preferably momentary switches; that is they are only active when being actuated. Thus, the actuation of the LATCH/RETRACT switch 140 causes the actuator 61 that controls the jack 62 to actuate, thereby causing the jack 62 to retract from the ground and also causes the actuator 32 that controls the latching hooks 30 to actuate, thereby causing the hooks 30 to rotate about the rod 20. Conversely, the actuation of the UNLATCH/EXTEND switch 150 causes these actuators to actuate in the opposite direction and cause the jack 62 to extend toward the ground and the latching hooks 30 to rotate so as to open. As mentioned above, separate independent controls can also be utilized to achieve this result. In such a scenario, separate switches can be placed on the wireless transmitter, corresponding to the different actuators.

FIG. 8 shows a representative schematic of the latching hook and jack actuators, such as hydraulic cylinders, that can be used in conjunction with the wireless transmitter of FIG. 7. The wireless receiver 37 is attached to the independent power source 36, typically via two connections; a power connection 200 and a ground connection 201. The wireless receiver 37 includes an antenna 38 that is adapted to receive signals from the wireless transmitter. The wireless transmitter can be located on or in the vehicle as described earlier. Alternatively, the transmitter 100 can be battery powered, and thereby portable so as to remain with or near the operator. Two solenoids are used to control the flow of hydraulic fluid into and out of the two cylinders. When the operator actuates the LATCH/RETRACT switch 140, channel A is activated, causing solenoid 210 to close, allowing fluid to flow into both cylinders. Conversely, when the operator actuates the UNLATCH/EXTEND switch 150, channel B is activated, causing solenoid 220 to close allowing fluid to flow from both cylinders. Also, when either switch is actuated, the common channel 230 is activated. The activation of the common channel closes the solenoid relay 240, which in turn activates the hydraulic unit 250, which can be a motor or pump. The release of the switch by the operator causes the solenoid relay 240 to open, thereby disabling the hydraulic unit 250. Therefore, the hydraulic unit 250 is active only at those times when the operator is actuating either of these switches.

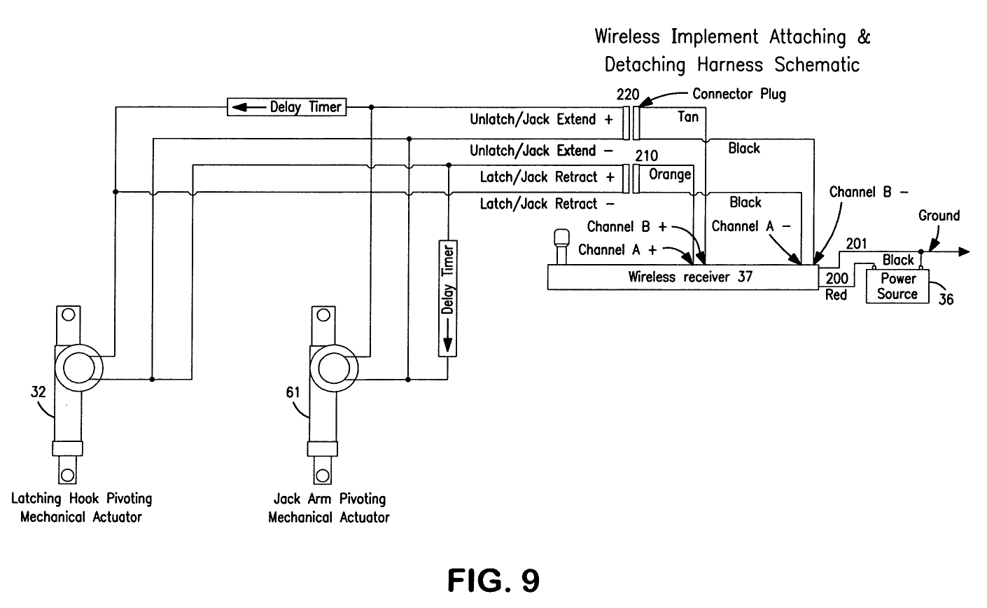

FIG. 9 shows an expanded schematic which corresponds to the wireless transmitter in FIG. 7. As was shown in FIG. 8, the wireless receiver 37 is powered by the independent power source 36. Channel A controls solenoid 210, while Channel B controls solenoid 220. When the UNLATCH/EXTEND switch 150 is actuated by the operator, the hydraulic unit 250 is activated and solenoid 220 closes. In this embodiment, this enables the jack actuator 61 to be activated immediately. After a short delay, the latching hook actuator 32 is activated. Thus, the jack 62 begins to extend before the latching hooks 30 release the rod 20. Alternatively, the two actions may occur simultaneously, or can be the results of separate controls. Conversely, when the LATCH/RETRACT switch 140 is actuated by the operator, the hydraulic unit is activated and solenoid 210 closes. In this embodiment, this enables the latching hook actuator 32 to be activated immediately. After a short delay, the jack actuator 61 is activated. Thus, the jack 62 begins to retract after the latching hooks 30 engage the rod 20. Alternatively, the two actions may occur simultaneously, or can be the results of separate controls.

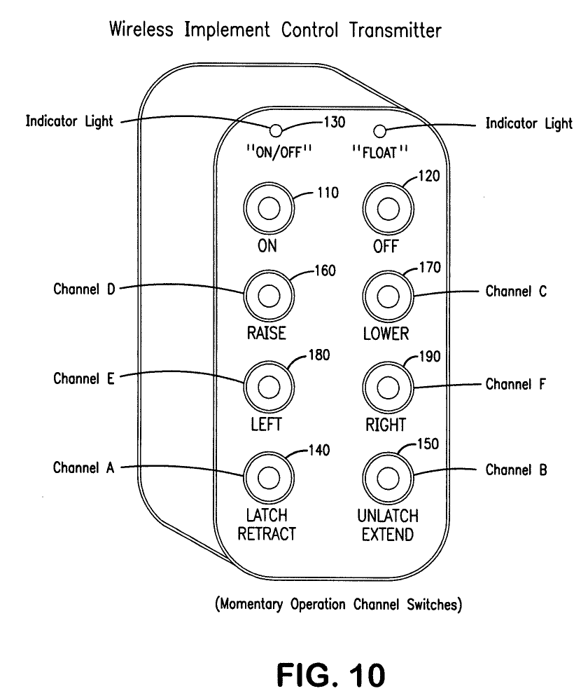

FIG. 10 represents a more complex version of the wireless transmitter. In this embodiment, all of the functions previously described with respect to FIG. 7 are still present. However, additional controls have been incorporated into the transmitter, such as controls that manipulate the implement, such as LEFT 180, RIGHT 190, RAISE 160 and LOWER 170 functions. These are not the only possible additional controls, nor do all of these controls need to be present in the current invention. By using a transmitter of this type, no physical connections are needed between the vehicle and the implement, since all controls are performed wirelessly. Each of the switches activates a separate channel on the wireless receiver, as is indicated by the designations in FIG. 10.

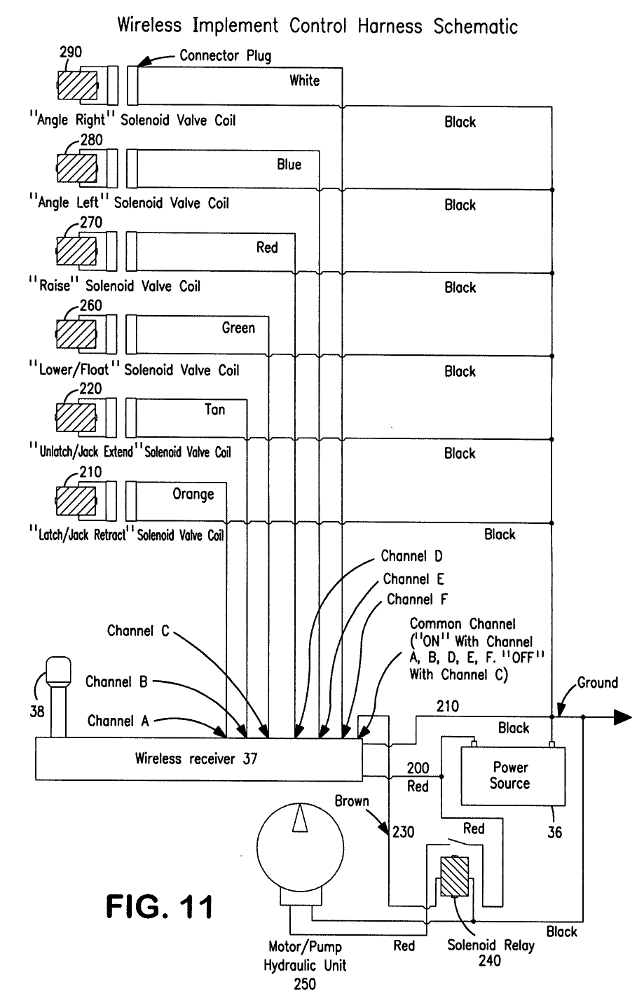

FIG. 11 shows a representative schematic of the wireless receiver that operates in conjunction with the wireless transmitter of FIG. 10. While this figure illustrates hydraulic cylinders being used as actuators, it is understood by those skilled in the art that other actuators are within the scope of the invention. Similarly, while solenoids are illustrated to control the flow of fluid into the cylinders, one skilled in the art will appreciate that any suitable switching device can be used. Each of the channels is connected to a solenoid, such that the actuation of a switch on the transmitter causes an activation of the corresponding solenoid. Note that, as before, the power source supplies power to the wireless receiver. Also, a common channel 230, which is activated by the presence of any of the other channels (except Channel C), enables a solenoid relay 240 that activates the hydraulic unit 250. In this embodiment, channel C is used to lower the working implement. The weight of the implement assembly is sufficiently heavy so as to be able to force the hydraulic fluid out of the cylinder once the solenoid is open. Therefore, there is no need to drive the hydraulic unit 250 to perform this function. Furthermore, this approach reduces the force with which the working implement contacts the ground when the lower switch is actuated. This is a matter of design choice and alternatively, all channels can be used to activate the common channel and therefore the hydraulic unit. As shown in FIG. 11, channels are provided to control the “ANGLE RIGHT” solenoid 290, the “ANGLE LEFT” solenoid 280, the “RAISE” solenoid 270 and the “LOWER/FLOAT” solenoid 260. It is obvious to one skilled in the art that this is only one embodiment and that others are possible and within the scope of the invention.

It should be noted that only the jack actuator 61 and latching hook actuators 32 must be controlled by the wireless controller, since these actuators must be operational before the vehicle is in contact with the implement assembly. All other controls can be performed wirelessly, or can be performed via a wired connection.

In addition to the implement itself, often additional electrical components need to be controlled. For example, often it is desirable, or even required by the applicable governmental regulatory authority, that lighting is provided on the implement. This lighting may include all lights typically provided on the vehicle itself, such as headlights, turn signals, flashers, parking lights, and high beams. Currently, most snowplow systems require a dongle or connector that passes through the grille of the vehicle to be attached to a mated connector on the implement. These connectors typically have a separate signal for each control that is required. Certain embodiments of the present invention eliminate the need for the operator to make this connection as well.

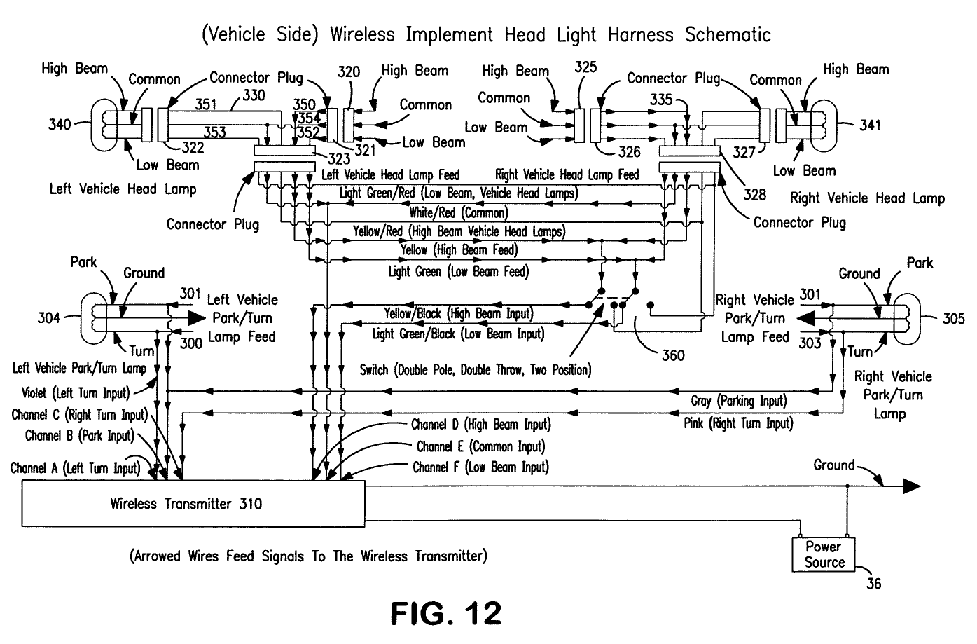

For example, FIG. 12 illustrates a representative schematic of the lighting system on the vehicle. Controls for the turn signals, such as turn 300 and park 301 are provided by the vehicle's electrical system. A pass-through connector is preferably used to connect these signals to their respective turn lamps and also connect these signals to a wireless transmitter 310. Using the wireless transmitter 310 in this manner, a duplicate set of lights can be provided on the implement. For example, when the operator activates the left turn blinker, the signal 300 is generated by the vehicle's electrical system and transmitted to the lift turn lamp 304. Simultaneously, the signal 300 is transmitted to a wireless transmitter 310. The wireless transmitter 310 then generates a wireless signal to the wireless receiver on the implement, indicating that the left turn blinker is active. Similarly, wireless signals are transmitted when the blinker is turned off or when the right turn blinker or parking lights are activated.

Typically, the control of the left and right headlights, such as high beam and low beam, is provided at connectors 320 and 325, respectively, by the vehicle's electrical system. These connectors typically are connected directly to the corresponding headlamps 340,341. In the embodiment shown in FIG. 12, these connectors 320,325 are instead connected to wiring harnesses 330,335. Each of these harnesses preferably has three connectors. The first 321, 326 connects to the vehicle's electrical output connector 320, 325. The second 322, 327 connects to the vehicle's headlights 340, 341. Finally, the third 323, 328 is used to bridge these together and to transmitter these signals to the wireless transmitter 310. Connectors 323, 328 preferably have at least 4 signals: high beam feed 350, high beam out 351, low beam feed 352, and low beam out 353. Most preferably, a fifth signal, common 354, is also included on the connector 323. The head beam feed 350 is the signal generated by the vehicle's electrical signal that is intended to drive the high beam lamp of the vehicle. The high beam out 351 is the actual signal that will be used to drive the vehicle's high beam lamp. The low beam feed 352 and low beam out 353 are analogous signals for the low beam lamp of the vehicle. The high beam feed 350 and low beam feed 352 signals are passed to a switching device 360, such as a double pole, double throw switch. When placed in one position, the vehicle headlights 340, 341 operate as is customary. When placed in the second position, the vehicle headlights 340, 341 are disabled from operation. This switch 360 is preferred controlled by the operator. In practice, the vehicle headlights 340, 341 are typically disabled when there is an implement which includes headlights attached to the front of the vehicle. In this scenario, the vehicle headlights 340, 341 are disabled, and only the implement headlights are used.

Returning to FIG. 12, when the switching device 360 is in the first position, the high beam feed 350 and low beam feed 352 are transmitted to the high beam out 351 and low beam out 353 signals, respectively, and no signal is provided to the wireless transmitter 310. When the switching device 360 is in the second position, the high beam feed 350 and low beam feed 352 are transmitted to the wireless transmitter 310 and no signals are provided to the vehicle headlights 340,341. The wireless transmitter 310 then transmits the status of the various headlight signals to the wireless receiver 37 located in the implement, as described earlier.

It should be noted that although this circuit allows the operator to disable the vehicle's headlights when an implement is connected, this is not required by the invention. Alternatively, the headlights of the vehicle may remain operational when the implement is mounted. In this scenario, the electrical wiring of the headlights would be similar to that of the turn and parking lights, and no switch 360 is necessary.

It should be noted that the wireless transmitter 310 described in conjunction with FIG. 12 may be, but need not be, the same wireless transmitter 100 described in FIGS. 7 and 10. This wireless transmitter 310 requires no interaction with the operator and therefore does not need to be located in proximity to the operator, such as within the passenger compartment. Rather, it can be optionally located in the engine compartment, closer to the electrical signals with which it is in contact. Alternatively, a wireless transmitter, which includes all of the functions described in FIGS. 7, 10 and 12, may be mounted within the vehicle's passenger compartment, such as on the dashboard or other convenient location, if desired.

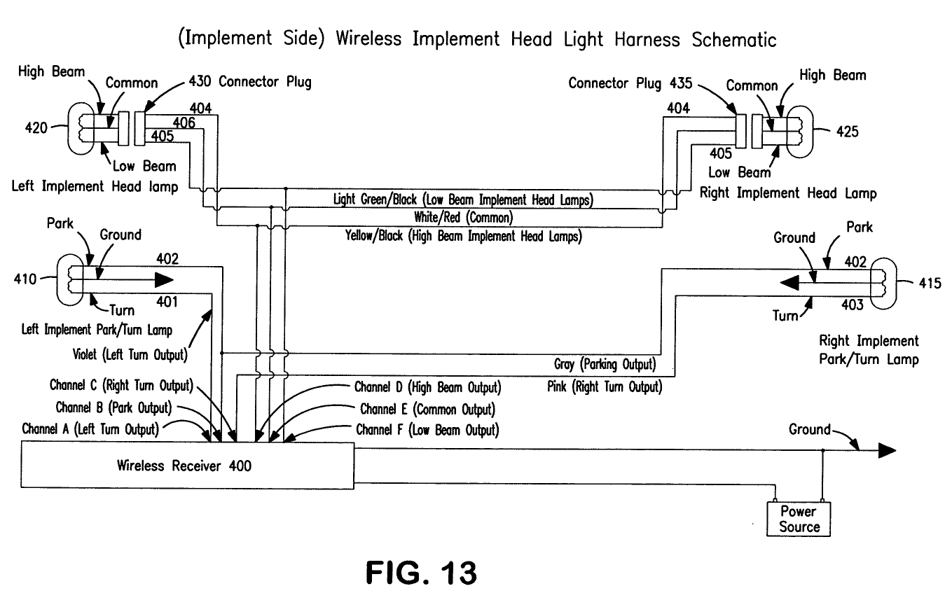

FIG. 13 illustrates a representative schematic of the implement lighting system. A wireless receiver 400 receives signals generated by the transmitter of FIG. 12. It then converts these wireless signals into a plurality of outputs, preferably six. In this embodiment, Channel A 401 is activated when the left turn signal within the left turn lamp 410 is to be lit, while the right turn signal with in the right turn lamp 415 is lit by the assertion of Channel C 403. The corresponding parking lights within the turn lamps 410, 415 are lit when Channel B 402 is activated. Similarly, the high beam lamps within the headlights 420, 425 are lit by the assertion of Channel D 404, while the low beam lamps are lit by the assertion of Channel F 405. These six outputs are configured so as to form one or more harnesses, which in turn connect directly to the corresponding lights. Preferably, two connectors 430, 435, designed to mate with the implement headlights, include Channels D 404, E 406, and F 405, arranged exactly as they would be by the vehicle connector. Two other connectors are designed to mate with the left and right turn lights 410, 415, and include Channels A 401 and B 402, and Channels B 402 and C 403, respectively. In this way, standard lights can be easily utilized in the implement. As was described with respect to the wireless transmitter, the wireless receiver 400 of FIG. 13 may be, but does not need to be, the same as the wireless receivers shown in FIGS. 7, 8 and 11.

Having detailed the individual components of the lighting system, the method by which they interact will be described. For example, the operator turns the lever so as to activate the left turn signal. A left turn signal 300 is generated by the vehicle's electrical system that is transmitted to the left turn lamp 304, and to the wireless transmitter 310 (as shown in FIG. 12). The wireless transmitter 310 then creates a wireless signal that is received by the wireless receiver 400 of FIG. 13. Any protocol, either commercially available or proprietary, can be used to relay the information from the transmitter to the receiver. For example, Bluetooth, WiFi or IrDA all provide standard protocols that can be employed. Alternatively, a proprietary protocol can be developed as desired. The wireless receiver 400 then receives the wireless signal and activates Channel A 401, which in turn lights the left turn lamp 410 of the implement. Later, when the wireless transmitter 310 transmits a signal indicating that the left turn lamp 304 is off, the wireless receiver 400 deactivates Channel A 401, thereby turning off the implement's left turn lamp 410. Analogous steps are taken for the right turn signal, the parking lights, the flashers, the low beam lights and the high beam lights.

While the above embodiment describes a system in which all signals are transmitted wirelessly from the vehicle to the implement assembly, the invention does not require this. In fact, there are various embodiments in which a combination of wireless and wired signals are employed to achieve the desired connections. As described earlier, it is only necessary that the jack extend/retract and the latch/unlatch controls be wireless, since these devices need to operate when the vehicle is not attached to the implement assembly. However, all other signals can be either wired or wireless.

There are numerous methods that can be used to transmit signals from the vehicle to the implement assembly using wires. As described earlier, a dongle exiting the vehicle near the front grille is commonly used. Preferably, a wired system that eliminates the need for the operator to manually connect the vehicle to the implement assembly is used.

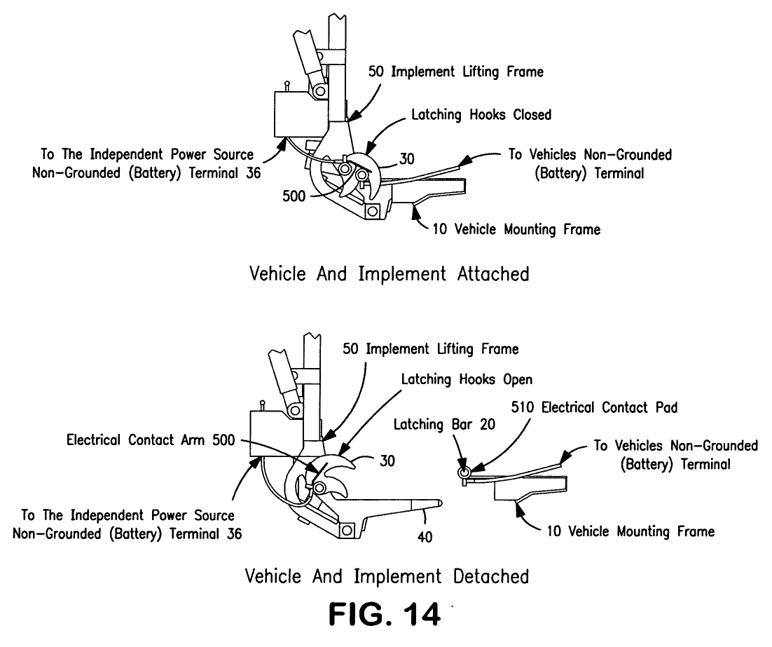

FIG. 14 shows a first embodiment of a wired connection between the vehicle and the implement assembly. In this embodiment, the vehicle receiver member 10 is connected to ground (as it preferably would be in all cases). Thus, the act of connecting the male members 40 of the implement assembly to the receiver member 10 creates a ground connection between the two devices. An electrical contact arm 500 is preferably located on one of the latching hooks 30, but is electrically and physically isolated from the hook 30. One or more electrical contact pads 510 are located on the rod 20 on the receiver member. These pads 510 must be electrically isolated from the rod 20, since the rod is grounded. When the latching hooks 30 are rotated so as to close about the rod, the electrical contact arm 500 comes in contact with the pad 510, thereby completing the connection. While one contact arm is shown on the outer edge of the left latching hook, the invention is not limited to this embodiment. Contact arms can also be placed near the right latching hook. Additionally, contact arms can be located on both the inner and outer edges of the latching hooks. Finally, more than one contact arm can be located in an area, as long as the arms are electrically isolated from one another and from ground. In this way, one or more electrical connections can be made between the vehicle and the implement assembly automatically upon contact between the implement assembly and the receiver member during the mounting procedure. One of the signals preferably connected is the positive side of the vehicle's battery (i.e. power). This connection supplies power which allows the independent power source 36 located on the implement assembly to be recharged, and also limits the power expended by the independent power source to only those actions that occur when the implement assembly is not connected to the vehicle (i.e. jack and latching hook movements).

As a safety precaution, the contact pads located on the vehicle rod can be disabled when not in use. For example, relays, solenoids or other switching devices can be placed in series between the source of the signal and the pad on the rod. These switching devices can be controlled in a number of different ways. In one embodiment, an operator driven switch, similar, or identical, to the one used to switch the headlights can be used to control the switching devices. For example, the operator switches the toggle switch, allowing the headlights of the implement to be operational, while disabling the vehicle's headlights. This action would also enable the switching devices, thereby allowing the electrical signals to flow to the electrical pads on the rod. In a second embodiment, the switching devices are controlled automatically. A signal is created by the implement assembly when it is connected to the vehicle. For example, the connection of the implement assembly may cause a signal to be grounded, or a circuit to be completed. This result is then used to drive the switching devices, thereby enabling the signals at the electrical pads. Other methods of generating a signal when two devices are in contact with each other is well know in the art and need not be described herein in specific detail.

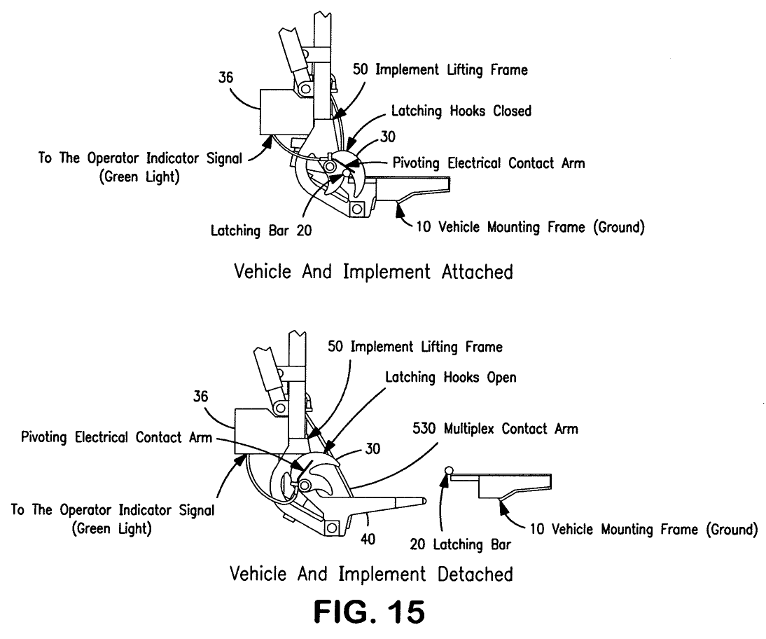

FIG. 15 represents a second embodiment of the wired connection scheme between the implement assembly and the vehicle. In this embodiment, the contact arms 530 on the implement assembly are preferably flexible, or may be spring mounted and extend into the area which is occupied by the rod when the implement is mounted to the vehicle, as shown in FIG. 15b. Thus, when the vehicle and implement are attached, the contact arms 530 press against the rod 20 and are pushed back by the rod 20, as shown in FIG. 15a. Upon removal of the implement, the contact arms 530 return to their rest position. A plurality of contact arms 530 can be spaced apart across the length of the rod. Each must be electrically isolated from the others and from ground. In corresponding locations, contact pads 510 are placed on the rod 20, such that when the implement and the vehicle are attached, the contact arms are aligned with the contact pads. The number of contact arms is an implementation decision, and is limited by the length of the rod, and the width of each contact pad.

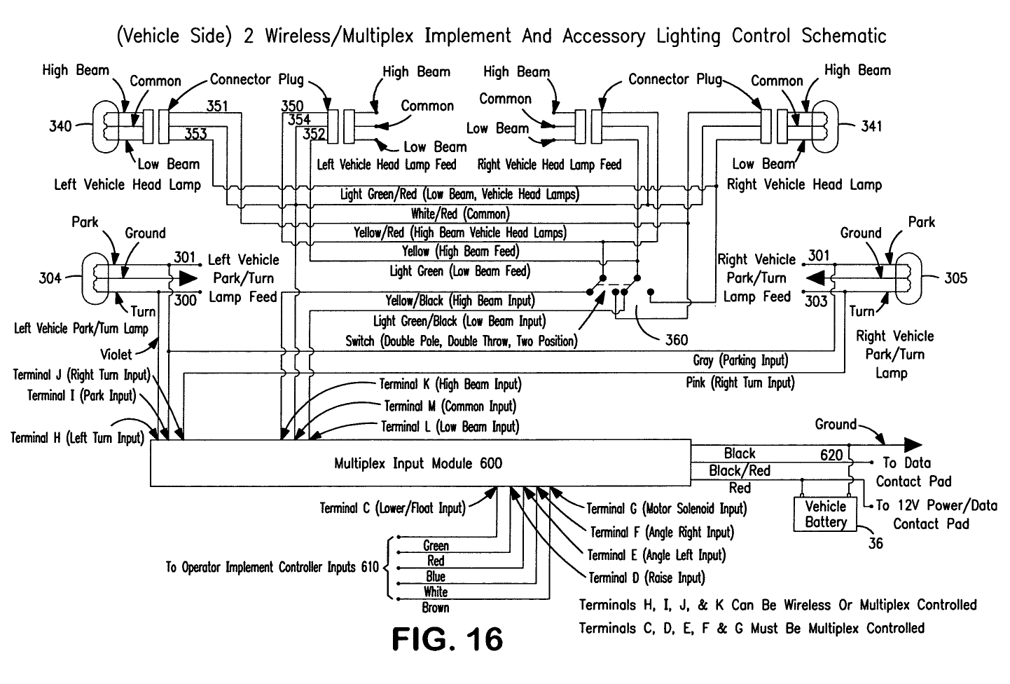

FIG. 16 illustrates one embodiment of a wiring scheme used to provide lighting and implement manipulation controls to the implement assembly. In this embodiment, the vehicle lighting system is connected as in FIG. 12. However, instead of using a wireless transmitter to relay the signals to the implement assembly, the lighting signals are input into a multiplex input module 600. The function of this module is to accept a plurality of signals and to generate fewer signals, preferably one, which multiplexes all of the inputs together. The multiplexer can operate in a number of ways. Both time-based multiplexing and frequency-based multiplexing are well known in the art, and can be used in this embodiment. Returning to FIG. 16, it can be seen that all of the lighting inputs, such as the high beam input 350, the common input 354, the low beam input 352, the left and right turn signals 300,303 and the parking lights 301 are input to the multiplex input module 600. Additionally, the controls used to manipulate the implement 610, such as angle left and right, raise and lower are also input to the multiplex input module 600. In the preferred embodiment, the multiplex input module 600 produces a single signal 620 that transmits all of this information to the implement assembly. The connection to the implement assembly is preferably made via contact pads on the vehicle side and contact arms on the implement side, as described above.

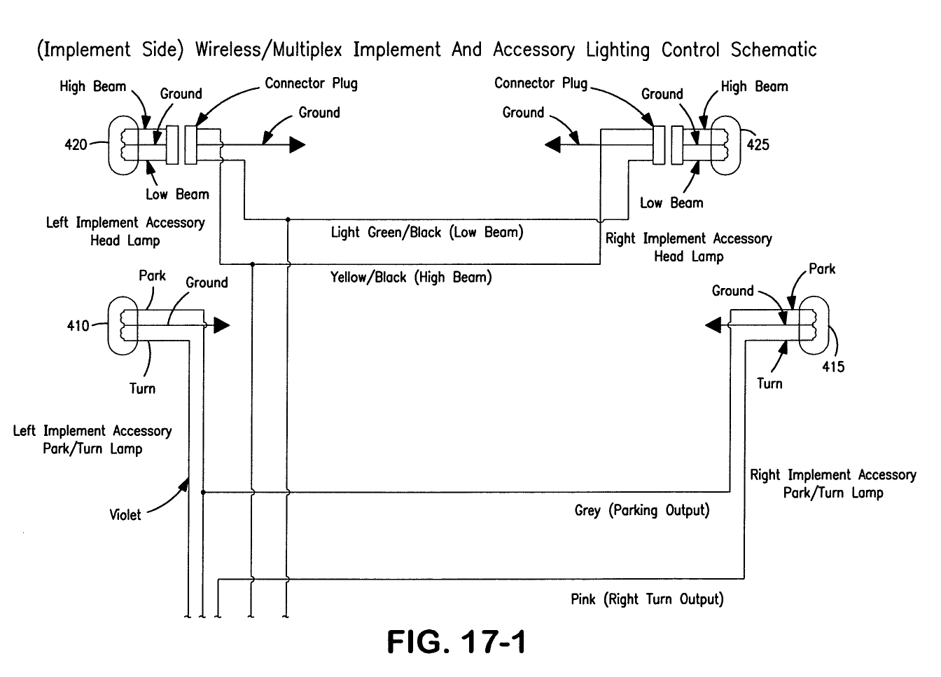

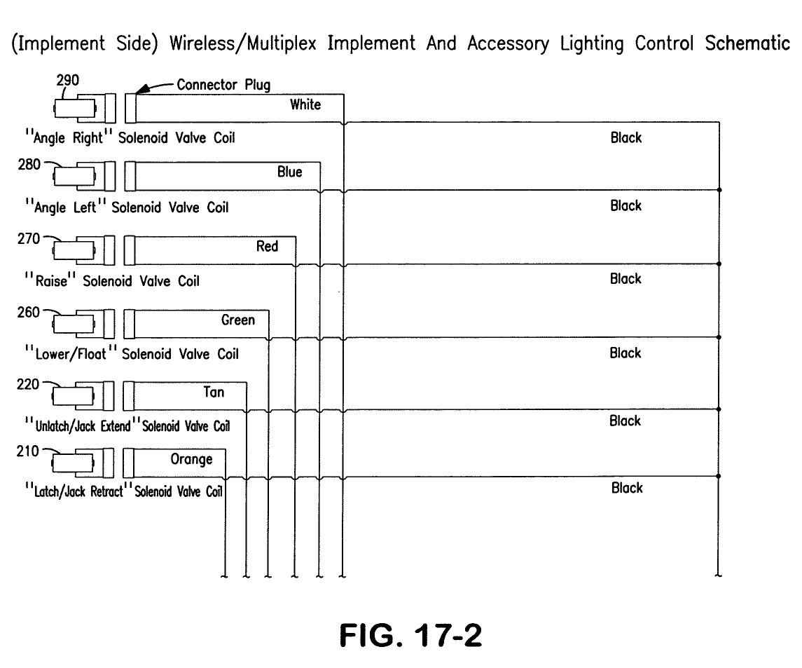

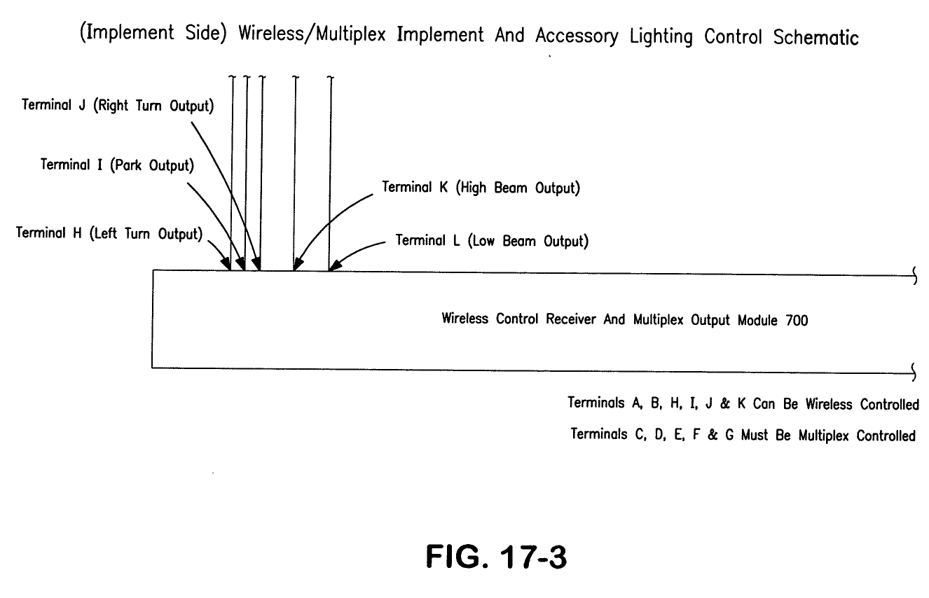

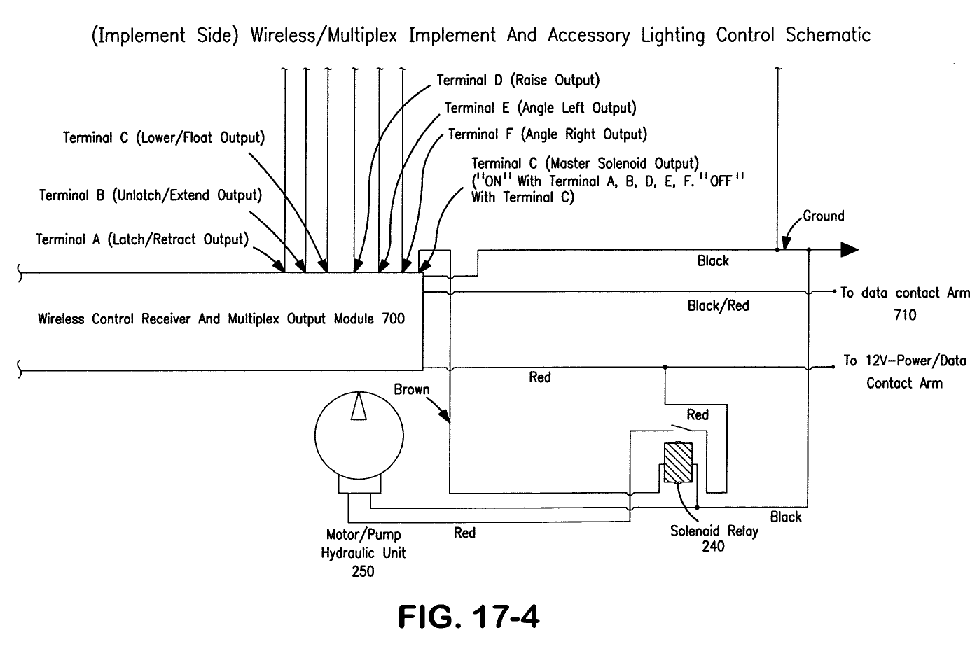

FIG. 17 represents the implement and lighting schematic of the implement assembly used in conjunction with the multiplexer of FIG. 16. A single wireless receiver and multiplex module 700 is shown. Alternatively, separate devices may be used for each function. In other words, a wireless receiver can be used to receive wireless signals and control the associated devices, while the multiplexer output module is used to receive the wired multiplexed signal (or signals) and control those associated devices. The operation of the wireless receiver has been previously described and will not be repeated here. The multiplex output module 700 receives the one or more multiplexed signals 710 from the vehicle, preferably via the contact pad and contact arm scenario described earlier. The module 700 then demultiplexes that signal 710 into its component parts and generates a unique signal for each. These signals are then used to control the respective associated devices, in the same way as described earlier with respect to the wireless receiver.

It is important to note that the transmission of most of the required signals can be done either via wireless communication or via wired communication. Only the jack control and the latching hook control must be performed wirelessly. Furthermore, although the preferred embodiment utilizes a multiplexer to reduce the number of signals that need to be physically connected between the vehicle and the implement assembly, this is not a requirement of the invention. If there is sufficient space, these wired signals can be connected separately, without the need to multiplex them. Multiplexing simply provides a method to reduce the number of connections required between the vehicle and the implement.

Finally, the choice of which signals to control wirelessly and which to control via wired connections is an implementation choice. Both methods are equally suited to perform the function.

What is claimed is:

1. A mounting assembly for attachment and detachment from a vehicle, comprising a hitch member and a frame, said hitch member being pivotably coupled to said frame for relative movement with respect to said frame; a receiver adapted to be coupled to said vehicle and being configured to receive said hitch member; at least one bar adapted to attach to said receiver or to said vehicle; at least one latch adapted to move from an open, unlatched position for detaching said assembly from said vehicle, and a closed, latched position for attaching said assembly to said vehicle; and at wireless remote control adapted to wirelessly actuate said at least one latch to said open and said closed positions.

2. The mounting assembly of claim 1, further comprising at least one latch actuator, and a wireless receiver on said mounting assembly for receiving wireless signals from said wireless remote control, and wherein said at least one latch actuator is responsive to said wireless signals received by said wireless receiver.

3. The mounting assembly of claim 1, further comprising an assembly control unit and electrical contacts on said assembly that, when said assembly is mounted to said vehicle, complete a circuit enabling electrical communication between said assembly and said assembly control unit.

4. The mounting assembly of claim 3, further comprising a working implement attached to said assembly, and wherein said assembly control unit controls the movement of said working implement.

5. The mounting assembly of claim 1, further comprising a jack associated with said hitch member, said jack being movable between a stored position and a hitch member raising position, and wherein said wireless remote control is adapted to move said jack between said positions.

6. A method of mounting a working implement assembly to a vehicle using wireless signals from a wireless transmitter, comprising providing an assembly receiver on said vehicle; providing a wireless receiver on said assembly; providing a jack on said assembly and at least one latch on said assembly, said jack and said at least one latch being responsive to signals from said wireless transmitter received by said wireless receiver; aligning said assembly into a suitable position for mounting to said vehicle by wirelessly actuating said jack; moving said vehicle towards said assembly; and causing said assembly and said receiver to engage by wirelessly actuating said at least one latch so that said latch engages said receiver.

7. An assembly suitable for mounting to a vehicle, comprising:
means for raising and lowering said assembly;
means for attaching said assembly to said vehicle; and
a power source for controlling said attaching means and said raising and lowering means.

8. A method of attaching an implement assembly to a vehicle, said assembly having means for raising and lowering said assembly and means for attaching said assembly to said vehicle, comprising:
wirelessly controlling said raising and lowering means to adjust the height of said assembly;
moving said vehicle toward said assembly; and
wirelessly controlling said attaching means to attach said assembly to said vehicle.

9. A system for providing electrical power to an assembly connected to a vehicle via a mounting rod comprising:
at least one contact pad on said mounting rod wherein said pad is in electrical communication with the power source of said vehicle; and
at least one contact on said assembly, which when said assembly is connected to said vehicle, is aligned with said pad.
